(19) United States
(12) Patent Application Publication
(10) Pub. No.: US 2026/0313386 A1
(43) Pub. Date: Oct. 8, 2026

(54) Scalalable Drone Swarm Networking with Unified 5G and Wi-Fi

(71) Applicant: Hughes Network Systems, LLC, Germantown, MD (US)

(72) Inventor: Rajeev GOPAL, Boyds, MD (US)

(73) Assignee: Hughes Network Systems, LLC, Germantown, MD (US)

(21) Appl. No.: 19/226,160

(22) Filed: Jun. 3, 2025

Related U.S. Application Data
(60) Provisional application No. 63/763,315, filed on Feb. 26, 2025.

(51) Int. Cl. H04W 16/18; H04W 24/02; H04W 28/02; H04W 52/02; H04W 84/06

(52) U.S. Cl. CPC H04W 16/18; H04W 24/02; H04W 28/0268; H04W 52/0219; H04W 84/06

(57) ABSTRACT

The disclosure provides support for a system and method for large-scale drone deployments, the system including: a Software-Defined Drone Network (SDSN) of drones connected via an integration of a licensed technology and an unlicensed spectrum technology, and a unified management module to manage a multi-layered connectivity, communication reliability and quality of service (QoS) for the drones per a baseline plan of a mission, wherein the SDSN provides the multi-layered connectivity via the integration using a spectrum collection including a licensed spectrum and an unlicensed spectrum. Robust operational endurance is extended through dynamic routing, predictive path optimization using Artificial Intelligence (AI)/Machine Leaning (ML) algorithms, and energy-efficient design. The SDSN integrates both Line-of-Sight (LOS) and Beyond Line-of-Sight (BLOS) communications.

### CROSS-REFERENCE TO RELATED APPLICATIONS AND INCORPORATION BY REFERENCE

The present application claims the benefit under 35 U.S.C. 119 (e) of U.S. Provisional Application Ser. No. 63/763,315 filed Feb. 26, 2025, which is incorporated herein by reference in its entirety.

### FIELD

The advent of drone technology has profoundly influenced both military operations and commercial sectors, offering unprecedented capabilities in surveillance, payload delivery, and large-scale autonomous operations. Particularly, the emergence of drone swarms—groups of low-cost drones that are operated together to achieve collective goals—has opened new avenues for both combat strategies and commercial applications within the country and around the world. The present teachings delve into the development of a Scalable Drone Swarm Network (“SDSN”) and addresses the challenges of scalability, security, and resiliency within drone operations. Unified management of energy, mission objectives, and spectrum can maximize the use of limited resources. Management functions on drones, driven by ground-provided policies and baseline plans, support autonomy when there is no or limited real-time ground control.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Recent European conflicts have underscored the strategic advantage that is provided by small, low-cost unmanned aerial vehicle (“UAVs”). These devices have been pivotal in reconnaissance, intelligence gathering, and delivering supplies, demonstrating a significant shift in how engagements are conducted. However, the deployment of drone swarms raises complex challenges, particularly in networking and common resource management where traditional communication systems and static control schemes are inadequate to handle the scale and dynamic nature of drone operations.

The disclosure also provides support for a system for large-scale drone deployments, the system including: a Software-Defined Drone Network (SDSN) of drones connected via an integration of a licensed spectrum technology and an unlicensed spectrum technology, and a unified management module to manage a multi-layered connectivity, communication reliability and quality of service (QoS) for the drones per a baseline plan of a mission, wherein the SDSN provides the multi-layered connectivity via the integration using a spectrum collection including a 5G spectrum and an unlicensed spectrum. In some embodiments, the licensed spectrum technology includes a 3rd Generation Partnership Project (3GPP) Fifth Generation (5G), Sixth Generation (6G) or the like technology.

In a first example of the system, the system further includes: an intelligence module configured to enable adaptive routing and decision-making processes by adapting to real-time operational dynamics.

In a second example of the system, optionally including the first example, the intelligence module includes at least one of an artificial intelligence (AI) algorithm and a machine learning (ML) algorithm.

In a third example of the system, optionally including one or both of the first and second examples, the SDSN adapts to one or more of the drones entering and exiting the SDSN while performing the mission.

In a fourth example of the system, optionally including one or more or each of the first through third examples, the unified management module includes a dynamic spectrum management module to dynamically manage allocation of the spectrum collection to maintain communication reliability and quality of service (QoS) within the SDSN.

In a fifth example of the system, optionally including one or more or each of the first through fourth examples, the unified management module includes a predictive analytics module to analyze network traffic, to predict a SDSN performance and to allocate SDSN resources based on the SDSN performance.

In a sixth example of the system, optionally including one or more or each of the first through fifth examples, the unified management module includes an energy-efficiency module to implement energy-saving techniques to prolong operation time of one or more of the drones.

In a seventh example of the system, optionally including one or more or each of the first through sixth examples, the SDSN is organized as a hierarchical network including a backbone layer including a backbone drone selected from the drones, a group coordination layer including a group coordination drone selected from the drones and a group layer including unmanned vehicles selected from the drones.

In an eighth example of the system, optionally including one or more or each of the first through seventh examples, the group coordination layer includes a plurality of group coordination layers, and the backbone layer organizes routing for the plurality of group coordination layers.

In a ninth example of the system, optionally including one or more or each of the first through eighth examples, the group layer includes a plurality of group layers, and the group coordination layer organizes routing for the plurality of group layers.

In a tenth example of the system, optionally including one or more or each of the first through ninth examples, one or more of either the backbone drone, the group coordination drone or the unmanned vehicles includes a RAN Intelligence Controller (RIC).

In an eleventh example of the system, optionally including one or more or each of the first through tenth examples, the backbone drone includes a cellular core.

In a twelfth example of the system, optionally including one or more or each of the first through eleventh examples, a correlation between a human operator to the unmanned vehicles is one to many.

The disclosure also provides support for a method for large-scale drone deployments, the method including: connecting a Software-Defined Drone Network (SDSN) of drones via an integration of a licensed spectrum technology and an unlicensed spectrum technology, and managing a multi-layered connectivity, communication reliability and quality of service (QoS) for the drones per a baseline plan of a mission, wherein the SDSN provides the multi-layered connectivity via the integration using a spectrum collection including a 5G spectrum and an unlicensed spectrum. In some embodiments, the licensed spectrum technology includes a 3rd Generation Partnership Project (3GPP) Fifth Generation (5G), Sixth Generation (6G) or the like technology.

In a first example of the method, the method further includes: enabling adaptive routing and decision-making processes by adapting to real-time operational dynamics using an intelligence module.

In a second example of the method, optionally including the first example, the SDSN adapts to one or more of the drones entering and exiting the SDSN while performing the mission.

In a third example of the method, optionally including one or both of the first and second examples, the method further includes: dynamically managing allocation of the spectrum collection to maintain communication reliability and quality of service (QoS) within the SDSN.

In a fourth example of the method, optionally including one or more or each of the first through third examples, the method further includes: analyzing network data, predicting a SDSN performance and allocating SDSN resources based on the SDSN performance.

In a fifth example of the method, optionally including one or more or each of the first through fourth examples, the method further includes: implementing energy-saving techniques to prolong operation time of one or more of the drones.

In a sixth example of the method, optionally including one or more or each of the first through fifth examples, the SDSN is organized as a hierarchical network including a backbone layer including a backbone drone selected from the drones, a group coordination layer including a group coordination drone selected from the drones and a group layer including unmanned vehicles selected from the drones.

Additional features will be set forth in the description that follows, and in part will be apparent from the description or may be learned by practice of what is described.

### BRIEF DESCRIPTION OF DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates a SDSN or an Integrated space and terrestrial network based on a licensed and unlicensed spectrums according to various embodiments.

FIG. 2 illustrates a SDSN including unified management to support mission objectives and autonomy according to various embodiments.

FIG. 3 illustrates a Unified Mission, Network and Computing Management logical diagram according to various embodiments.

FIG. 4 illustrates a SDSN deploying a multi-layer architecture according to various embodiments.

FIG. 5 illustrates a SDSN deploying a hierarchical network architecture according to various embodiments.

FIG. 6 illustrates a SDSN deploying a hierarchical computing architecture according to various embodiments.

FIG. 7A illustrates a hierarchical mesh network integrating an IAB transport according to various embodiments.

FIG. 7B illustrates a hierarchical mesh network integrating a Sidelink transport according to various embodiments.

FIG. 7C illustrates a hierarchical mesh network integrating IAB, Sidelink, and Wi-Fi transports according to various embodiments.

FIG. 8 illustrates a SDSN including an O-RAN RIC-based dynamic beam forming and spectrum transport according to various embodiments.

FIG. 9 illustrates a resilient wide-area connectivity overlay on transports according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well as any other variations, appearing in various places throughout the specification are not necessarily all referring to the same embodiment.

### I. INTRODUCTION

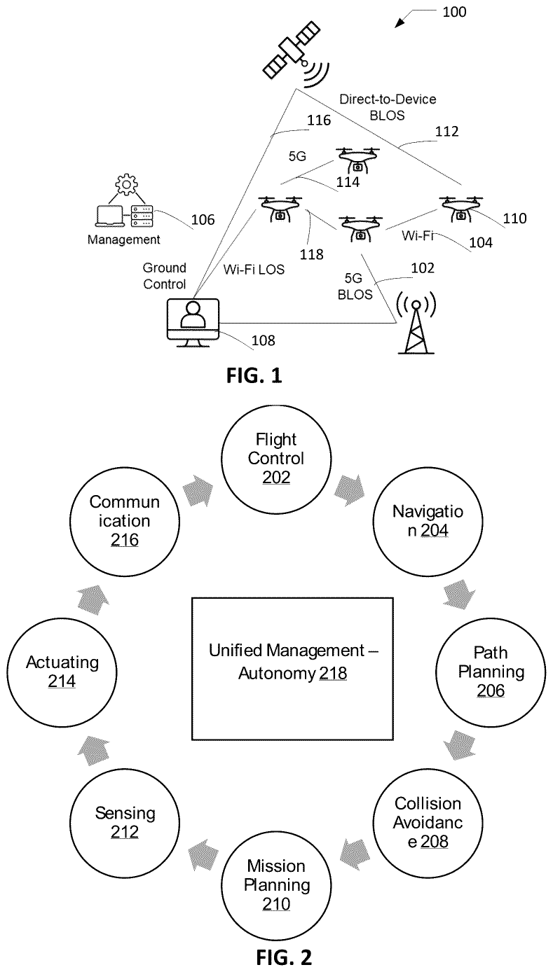

FIG. 1 illustrates a SDSN or an Integrated space and terrestrial network based on licensed and unlicensed spectrums according to various embodiments.

A proposed SDSN architecture aims to overcome these limitations by integrating advanced licensed (for example, 3GPP 5G, 3GPP 6G) and unlicensed (for example, Wi-Fi) spectrums and associated technologies to facilitate robust, scalable, and secure communications. The network supports hundreds to thousands of drones, enabling operations that range from targeted military strikes to extensive agricultural and infrastructural monitoring. By leveraging both line of sight (“LOS”) and beyond line of sight (“BLOS”) communications, the network enhances operational flexibility and extends the reach of drone applications. Though primarily focusing on UAVs, the SDSN architecture is directly applicable to unmanned terrestrial and marine systems.

FIG. 1 illustrates an Integrated space and terrestrial network (ISTN) or SDSN 100 including a hybrid system employing licensed spectrum transports (terrestrial 5G transport 102, satellite-based direct-to-device transport 112, and O-RAN RIC 5G and unlicensed spectrum transports (Wi-Fi 104) networking. In some embodiments, a satellite-based broadband transport 116 may be integrated into SDSN 100. In some embodiments, an unlicensed spectrum transport 118 may be integrated into SDSN 100. SDSN 100 provides a multi-layered approach to connectivity and leverages a diverse collection of licensed and unlicensed spectrum.

SDSN 100 increases the resilience and redundancy of the network and facilitates a scalable architecture capable of expanding or contracting based on operational demands. For instance, Wi-Fi 104 can efficiently handle short-range communications within small swarms, while 5G transport 102 technologies extend the operational domain by enabling BLOS connectivity. BLOS connectivity provided by 5G transport 102 may be used for expansive drone operations across diverse geographical landscapes.

Spectrum diversity across licensed and unlicensed spectrums further enhances the overall resiliency. SDSN 100 includes network management 106 and ground control 108 for any mobile devices such as drones 110. SDSN 100 incorporates features such as dynamic spectrum management, predictive analytics, and energy-efficient designs to optimize the network's performance and sustainability. These features maintain communication reliability and Quality-of-Service (QoS) in complex scenarios involving drones 110. The drones 110 may be deployed with varied mission objectives and energy. AI and ML algorithms may provide the features to enhance capabilities of SDSN 100 by enabling adaptive routing and decision-making processes. The features of SDSN 100 may anticipate and react to operational dynamics in real-time or near real-time (for example, less than in 1-second).

The commercial implications of the SDSN are vast and varied. In agriculture, drone swarms can be utilized for precision farming techniques, such as targeted pesticide/herbicide application and crop monitoring, which can significantly increase efficiency and crop yield. In infrastructure, drones can perform regular inspections of hard-to-reach areas, such as bridges, factories, pipelines, power transmission, solar farms, windmills, and skyscrapers, thereby reducing maintenance costs and improving safety. Furthermore, in emergency response scenarios, swarms can facilitate both rapid and cost-effective assessments of disaster-stricken areas, providing data to first responders and rescue teams.

### II. ARCHITECTURAL OBJECTIVES AND DESIGN APPROACHES

FIG. 2 illustrates a SDSN including unified management to support mission objectives and autonomy according to various embodiments.

A scalable swarm network represents a significant technological advancement in drone operations. SDSN facilitates both inter-drone and ground control links. The varied links provide a substrate for unified management 218. Unified management 218 may be used to manage and/or apportion limited computing, spectral, and energy resources. Unified management 218 provides many building blocks, that can be orchestrated within a drone, with onboard management based on baseline plans and policies, even when ground control is compromised. By addressing the core challenges of scalability, security, and resiliency, the SDSN paves the way for more sophisticated and widespread use of drone swarms, fundamentally altering the landscapes of military engagement and commercial enterprise. Unified management 218 may include subsystems for Flight Control 202, Navigation 204, Path Planning 206, Collision Avoidance 208, Mission Planning 210, Sensing 212, Actuating 214, Communication 216 or the like.

### A. Mission Execution Flexibility

The SDSN provides unparalleled flexibility and efficiency in mission execution, accommodating a wide range of operational scenarios from centralized to distributed drone control, with or without real-time ground control. The architecture supports both single swarm and clusters of swarms' operations, which can be scaled according to mission needs. This is enabled by the network's capability to manage (prioritized) user data, drone commanding, and safety protocols within the swarm and in communication with ground control.

A standout feature of the approach leverages the network's soft programmability (software-defined architecture), ensuring that if any captured drone becomes non-functional, swarm and network roles can adapt (within the confines of baseline ground plans and policies) thus enhancing operational security.

Connecting technologies include existing wireless networks, both terrestrial and space, to support operations around the world. Large parts of populated areas are already covered with cellular networks and emerging non-terrestrial network (“NTN”) capability can now span the remaining geographical areas (including sparsely populated and/or lacking terrestrial coverage).

### B. UAV Network Environment

The network interface for UAVs in the SDSN emphasizes minimal Size, Weight, Power, and Cost (SWAP-C) for operational efficiency, cost-effectiveness and deployment scalability. It supports connectivity in both licensed (such as 5G, 6G) and unlicensed spectrums (such as Wi-Fi or citizens band radio service (“CBRS”)), enabling robust communication under diverse conditions. Automated selection of communication links and efficient traffic distribution are managed dynamically—onboard network control—to optimize mission performance. The interface prioritizes energy conservation and link management at the UAV level, likely crucial for extended missions and prioritizing communications, thereby enhancing the overall effectiveness of the drone swarm.

### C. Resiliency and Security

The SDSN architecture integrates resiliency and security features to ensure reliable and secure operations. Dynamic routing capabilities allow the network to adapt in real-time to changes in drone positioning and network conditions to maintain communication integrity and continuity under various threats. Furthermore, the network design may include policies for the autonomous orchestration of wide-area links at gateways, enhancing the system's ability to withstand potential cyber threats, spectral compromises, and physical failures. Security measures may be deeply ingrained, encompassing confidentiality, availability, and integrity of links and network nodes, backed by active management for provisioning, performance, fault handling, and security.

### D. Network Design Objectives

The architecture of the SDSN places a strong emphasis on scalability, dynamic topology, and efficient, real-time communication. These objectives support a large-scale network for managing numerous drones across varied operational environments. The architecture addresses bandwidth limitations and interference challenges that escalate with increasing swarm sizes, using dynamic spectrum and power allocations to enhance performance. Furthermore, the system employs decentralized, self-healing routing and predictive and reactive path optimization to ensure robustness and responsiveness, for maintaining operational continuity and effectiveness in complex, dynamic environments.

TABLE I
SDSN NETWORK DESIGN OBJECTIVE DRIVERS

| Network Feature | Design Objective Driver |
|---|---|
| Network | Support large-scale communications with dynamic |
| Scalability | adjustments |
| Dynamic | Adapt to changing drone positions which may deviate |
| Topology | from the baseline |
| Real-Time | Enable coordination and data exchanges amongst |
| Communication | drones and ground |
| Energy Efficiency | Balance performance with power consumption and |
| | energy budgets |
| Network | Ensure robust policy, baseline configuration, |
| Management | performance, and fault management, domain AI/ML |
| | models |

### E. Unified Management

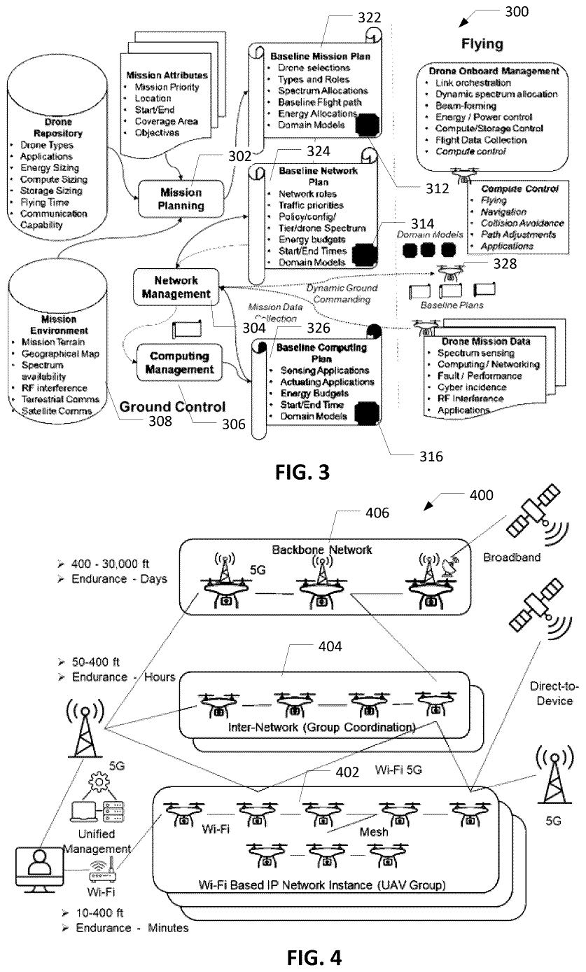

FIG. 3 illustrates a Unified Mission, Network and Computing Management logical diagram according to various embodiments.

The SDSN dynamically supports mission objectives within the confines of a unified management 300 of mission planning (objective) management 302, network management 304, and computing resource management 306. The unified management 300 may be associated with a drone swarm executing a planned mission. The role of network management 304, within this unified management 300, is shown in FIG. 3 with respect to environmental repositories 308, automated planning, and baseline planning, which provides a substrate for dynamic adjustments while a mission is executed. Baseline planning may be based on a baseline mission plan 322, a baseline network plan 324, and a baseline computing plan 326. Baseline mission plan 322, baseline network plan 324, and baseline computing plan 326, or relevant portions thereof, may be communicated to drones 328.

Domain Models for mission 312, environment (not shown), network 314, and computing 316, which are primarily generated on ground, play a key role in enhancing drone autonomy. These models range from simple tables to generative AI, (e.g., Large Language Models, LLM) which is summarized in the following table. Simulations engines typically are computation intensive and typically ground-based. Simulations engines can be used as digital twins for playing what-if scenarios and mission planning.

TABLE II
DOMAIN MODELS FOR AUTONOMY

| Model | Features | Challenge |
|---|---|---|
| Software | Procedural description of | Expensive and hard coded |
| | situations, behavior and | implementation, costly to |
| | specific actions | maintain and lifecycle delays |
| Simulation | Discrete event; | Slow execution speed and |
| Engines | implementations, analytical | limited to small domains for |
| Physics | formulations | precise behavior. |
| Models | | |
| Tables | Parametric description of | Fast response but too |
| | situational action taking | simplistic to capture complex |
| | | scenarios |
| Executable | If-then-else logic used in | Human readable and machine |
| Rules | traditional AI expert | executable. Transparent |
| | systems, with domain | autonomous behavior for |
| | semantics and situational | applications. Requires human |
| | action taking | experts |
| Traditional | Unsupervised learning for | Supervised learning is human |
| Machine | clustering and supervised | labor intensive, and both |
| Learning | learning (neural networks) | require large amounts of |
| | | representative data |
| Latest | Most sophisticated and | Requires large amount of |
| Generative | creative autonomous | computations, energy, and |
| AI | situational actions for a | data for training. Delusional |
| (LLM) | variety of domains. Holds | for critical applications. |
| | significant promise | Work in progress |

### F. Regulatory Constraints

Drones fly within the constraints of regulatory agencies responsible for spectrum coordination, aircraft flying, and public safety. For example, the USA has strict licensing requirements for any drone weighing more than 0.55 pounds with additional restrictions for drones with weights exceeding 55 pounds. Moreover, there is a requirement for a digital identification with Remote ID, governed by US Federal Aviation Agency (FAA) through a certification process. In addition, most of the private flights are constrained to within 400 feet and under strict visual line of sight (VLOS). Formal certification is needed for commercial drones that exceed these basic limits. Currently larger drones, typically weighing more than 500 pounds, are used by governments.

Any wireless communication in the SDSN may comply with spectrum and power framework specified by a regulatory agency. For example, unlicensed ISM bands for most consumer applications while commercial applications, especially for BLOS operation, may use licensed spectrum. The ISM radio bands are portions of the radio spectrum reserved internationally for industrial, scientific, and medical (ISM) purposes, excluding applications in telecommunications.

### III. SDSN ARCHITECTURE AND DESIGN

The SDSN architecture provides hierarchical and resilient communication across extensive drone operations. This architecture integrates multiple layers that are supported by individual drones for collective swarm management, optimizing both LOS and BLOS communications.

Utilizing a combination of licensed and unlicensed spectrum technologies, the network supports various operational scales, from small to large-localized swarms, for distributed operations. Enhanced by satellite Direct-to-Device (D2D) connectivity and smart networking capabilities, the SDSN fosters robustness and operational efficiency that is crucial for managing complex drone deployments.

### A. SDSN Architecture

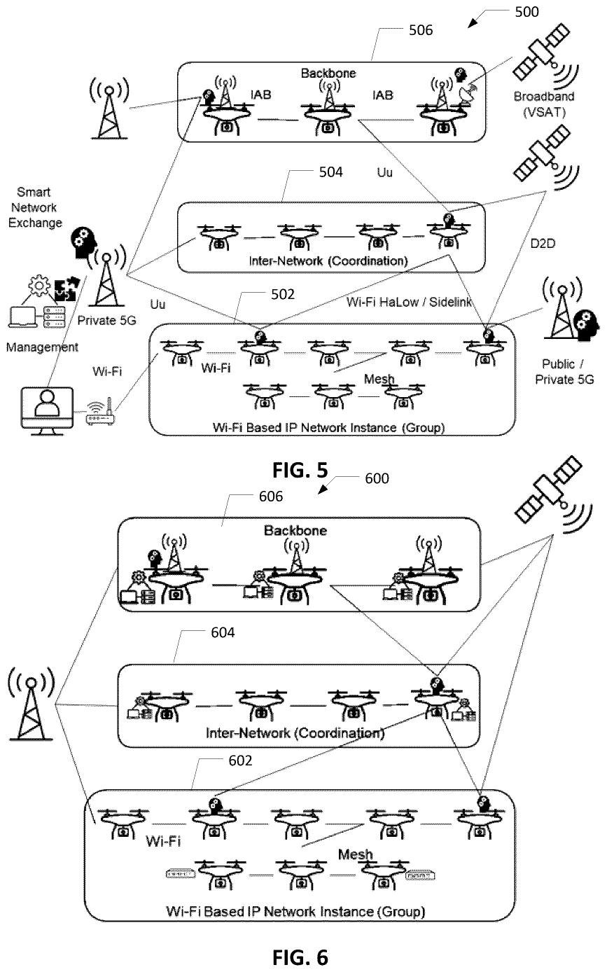

A hierarchical structure of exemplary SDSNs (400, 500, 600) features multiple layers, for example, as shown in FIG. 4, FIG. 5 and FIG. 6. Each layer of the SDSN facilitates specific aspects of swarm control and data transmission. A bottommost or UAV group layer (402, 502, 602) handles direct drone-to-drone interactions, a middle or inter-network layer (404, 504, 604) coordinates groups of drones, and the topmost or backbone layer (406, 506, 606) aggregates user data, network data, and commands across the network.

This layered or tiered approach enhances communication efficiency and enables diverse spectrum usage (licensed and unlicensed spectrums), and scalable expansion and contraction of drone operations per a mission's objectives. Resilient communications transports to the ground ensure continuous control and oversight, crucial for mission-critical operations.

### B. SDSN Layered Design

A hierarchical approach allows the use of larger UAVs with more energy/power and computing resources at coordination and backbone layers. The UAVs in these two layers are positioned at higher altitudes with a larger field-of-view, spanning hundreds of miles for a backbone drone at 30,000 feet and about 25 miles for a drone at 400 feet. Thus, the higher layers can leverage high capacity BLOS links with terrestrial transports (both licensed and unlicensed spectrums). They can connect multiple groups within a swarm. The multiple groups may be physically located over large geographic areas (for example, within a 50-mile diameter area for a drone in the middle layer at 400 feet and coordinating lower layer drones within the area).

Hierarchical Networking for Scalability—Each UAV group is coordinated by the middle layer, while the backbone layer aggregates communications to ground control for additional oversight.

Multi-link Connectivity—Employs Wi-Fi for LOS communications, supplemented by BLOS for all layers, ensuring robust BLOS and inter-network connectivity. In addition, terrestrial transports provide an enhanced capacity and range, primarily supporting higher network layers and backhaul needs.

Satellite D2D Connectivity—Facilitates satellite D2D communications using cellular capabilities, enhancing the flexibility and reach of network connections.

Node Role and Link Assignments—Incorporates predefined node roles and link usage policies as a part of the baseline mission and network plans, ensuring efficient and secure network operations.

Dynamic Link Setup and Use—Supports autonomous decision-making at the node level, governed by the overall mission plan to optimize network performance and adapt to changing conditions.

### C. Networking Architecture

SDSN employs a mix of Wi-Fi for short-range, LOS communication, and cellular technologies for longer-range and BLOS connections. This setup facilitates seamless internetworking across different layers and operational groups, ensuring that each drone can maintain constant connectivity with the network infrastructure. Advanced routing protocols manage the data flow across the network, optimizing for both performance and energy efficiency. Gateways in one or more layers of the SDSN allow for dynamic adjustments in network topology and link usage to maintain network integrity in dynamic operational environments.

A key part of any wireless network is the precise use of energy and spectrum resources for radio links connecting two nodes. Beam forming antennas can dynamically adjust directivity, power, and coverage based on network traffic load and environmental state (intra- or inter-system interference). In some embodiments, the SDSN leverages a 5G O-RAN-based RAN Intelligence Controller (RIC) for the beamforming, for example, between layers of the SDSN, or between gateways within a layer. Policies in baseline plans for spectrum sensing and decision-making may guide each drone. The baseline plans support autonomous decision-making at each drone for sustaining adequately sized links without wasting resources.

### D. Network Design Features

The SDSN provides extended coverage for the multi-tier drone locations by deploying some of the layers at higher altitudes. SDSN utilizes features of 5G and O-RAN such as the latest capacity, QoS, security, and management (using licensed spectrum) features. SDSN may also leverage the recent Wi-Fi 7 advancements and may use the unlicensed spectrum. The features of the SDSN, without limitation, provide the following advantages.

Hierarchical Network for Scalability—Establishes high-altitude UAVs in the backbone network to support aggregate capacities and directional antenna utilization for beamforming. Uses/implements dynamic routing protocols like Open Shortest Path First (OSPF) and Border Gateway Protocol (BGP) to manage data flow across the network.

Internetwork Across Group—Utilizes directional antennas to increase communication distances, employing long-distance Wi-Fi HaLow, 5G Integrated Access Backhaul (IAB), and 5G Sidelink for effective inter-group networking. It may also facilitate routing across individual Internet Protocol (IP) networks to support enhanced connectivity and coordination.

IP Network at Group Level—Features a Dynamic Wi-Fi Mesh (DWM), built upon IEEE standards-based interfaces, which is capable of precision routing of multi-priority traffic in user, control, and management planes. It may allow for potential gateway setups at a SDSN layer, enhancing the flexibility and resilience of the network architecture.

Multi-transport Orchestration—Integrates the Smart Network Edge (SNE) on nodes with network gateways, optimizing gateway selection, load sharing across multiple transports, and prioritization. It further supports the comprehensive Virtual Private Network (VPN) management and routing across ground networks through Smart Network Exchange (SNX).

### E. Computing Architecture

Computational capabilities within the SDSN are distributed according to the hierarchical network structure, and mission needs are captured in the baseline mission and computing plans. High-performance compute resources can be allocated at the backbone for the processing of larger user datasets, AI/ML model refinements, and data-intensive mission coordination and network activities. Middle and group levels possess moderate to minimal compute power and storage, sufficient for real-time mission data processing and decision-making within respective operational scopes at coordination layer.

This distributed computing architecture supports the scalability of drone operations and ensures that the computational tasks are managed efficiently, close to the respective data sources, reducing latency, and enhancing responsiveness of the swarm to operational commands. Each network layer has AI-enhanced capabilities that commensurate with its computing capabilities to facilitate autonomous decision-making and optimization of network, computing, and energy for mission tasks.

The level of autonomy within a swarm drives the amount of computation and energy resources needed to support a mission. Autonomy is needed for flying drones in a safe manner without any real-time connectivity with the ground control. On the other hand, connectivity to the ground becomes more important, requiring additional computing resources for network functions, when the level of autonomy is reduced. In either case, a judicious and balanced use of computing resources across networking and autonomy is an important part of the unified management approach. This balance may be captured in the baseline plans and is adjusted as the mission is executed with changing environmental conditions.

### F. Computing Design Features

General purpose computers provide a modern containerized software environment to run various mission, networking, safety, and drone flying functions.

Multiple Roles for Drones—Drones serve varied functions, such as Command and Control (C2), ISR, and munitions delivery. Each drone implements multiple, not necessarily all, drone subsystems, for example, subsystems shown in FIG. 2. Unified management assigns network data routing points and coordinates swarm mobility, roles, location, and safety. Unified management includes baseline plans created on the ground. Unified management may dynamically adjust baseline plans within the drones.

Leveraging Network Flexibility—Supports either a single large swarm or multiple smaller swarms that are tailored to specific roles and missions. Further leveraging the robust network infrastructure provided by the SDSN enhances swarm control, autonomy, and mission data coordination with unified management.

Hierarchical Edge Compute—Unified management distributes compute resources across the network hierarchy: highest level in the backbone, coordination level, and dedicated small compute/storage at UAVs. Further, multi-Control Processing Unit (CPU) setups and substantial storage at higher levels are used to manage the complex computations and data storage needs. Moreover, time-sensitive functions may be assigned to smaller drones in the lowest layer. Also decides “send vs. store” under constrained situations.

Backbone Edge Compute—Backbone may be equipped with significant computational power (multiple servers and terabytes of storage) and storage capabilities to support medium-size models and extensive data requirements. Also, ample power and energy budgets may be featured to handle the demanding computational tasks and support a cloud-based model integration.

Coordination and Group Level Compute—Coordination level may include multiple CPU cores and extensive storage, for example, hundreds of gigabytes, for dynamic data sharing and small AI model operations. Group level compute involves at least one CPU and multi-gigabyte storage, focusing on sensing/actuating, and very small LLM models for local decision-making and operational efficiency.

G. Resiliency with NMS, SNE, and SNX

The communication resiliency within the SDSN emphasizes the integration of agile orchestration that enhances network reliability and security. The focus is on implementing autonomous decision-making to ensure stable and secure communication. Key elements include the SNE for flexible terminal management; the Smart Network Exchange (SNX) as an aggregator for user traffic; and Network Management System (NMS) for comprehensive swarm monitoring, policy management, baseline plan generation, and overall coordination. The SNE is hosted by a drone with multiple Wide Area Network (WAN) links while the SNX is typically on ground for traffic aggregation. The NMS itself is on ground (collocated with ground controller or in cloud).

These systems leverage automated decision-making and policy control, which are optimized by AI/ML techniques and are crucial for managing complex network scenarios and ensuring elevated levels of data security and operational efficiency. Policies and configuration data are coded as human-readable, but machine process-able rules are executed by rules-engine for autonomous decision-making.

The Network Management System (NMS) serves as the central management hub for the SDSN, overseeing resource allocation, terminal registration, and distributing mission planning, networking, and computing baselines. The NNS utilizes AI/ML for efficient network planning based on user input, available drone configurations, and spectrum availability; policy refinements based on global knowledge and state of drone resource; and performance enhancements based on collected network and drone energy and spectral use data. The NMS may provide a swarm-level unified view (utilizing network application, spectrum, energy, and mission data collected from the swarm) for situational awareness and security operations management across the network.

The Smart Network Edge (SNE) manages multiple gateways and links at the network edge, automating decision-making processes to optimize policy control and traffic routing between drones and external nodes. The SNE enhances communication resiliency by adapting to changes in network conditions, which are supported by modern AI/ML techniques that ensure optimal performance and security.

The Smart Network Exchange (SNX) acts as an aggregator for managing and routing edge traffic, centralizing control over distributed network nodes to streamline operations. The SNX incorporates VPN management and routing capabilities, allowing for the sophisticated handling of network data flows and enhancing the overall network security and stability.

### IV. SDSN IMPLEMENTATION APPROACH

### A. 5G Integration

The use of 3GPP 5G within the SDSN enhances network capabilities and expands operational reach beyond traditional LOS constraints. The use of 5G networks brings extensive coverage that is supported by terrestrial or non-terrestrial cellular networks and enables satellite Direct to Device (D2D) communications.

Seamless connectivity across complex operational environments and large BLOS coverage areas, for both intra-swarm and inter-swarm communications, is enabled by a robust framework integrating 5G into the SDSN architecture. Standards-based 5G allows the use of off-the-shelf UE communications modules with highly optimized (for SWAP-C) implementations suitable for resource constrained drones. The inherent advantages of 5G—and implementation flexibilities enabled with O-RAN framework, including high data rates and low latency—enable real-time control and data exchange among drones. This allows the implementation of SDSN-specific IAB designs that are suitable for limited energy drones. The availability of O-RAN standards-based RIC decision-making allows sourcing of RAN components from multiple organizations while establishing dynamic spectrum sharing, energy management, and beam forming capabilities in drone-based RANs. Similarly, 5G Sidelink—with User Equipment-to-User Equipment (UE-to-UE) connectivity—can also be used to extend the coverage of 5G network within SDSN.

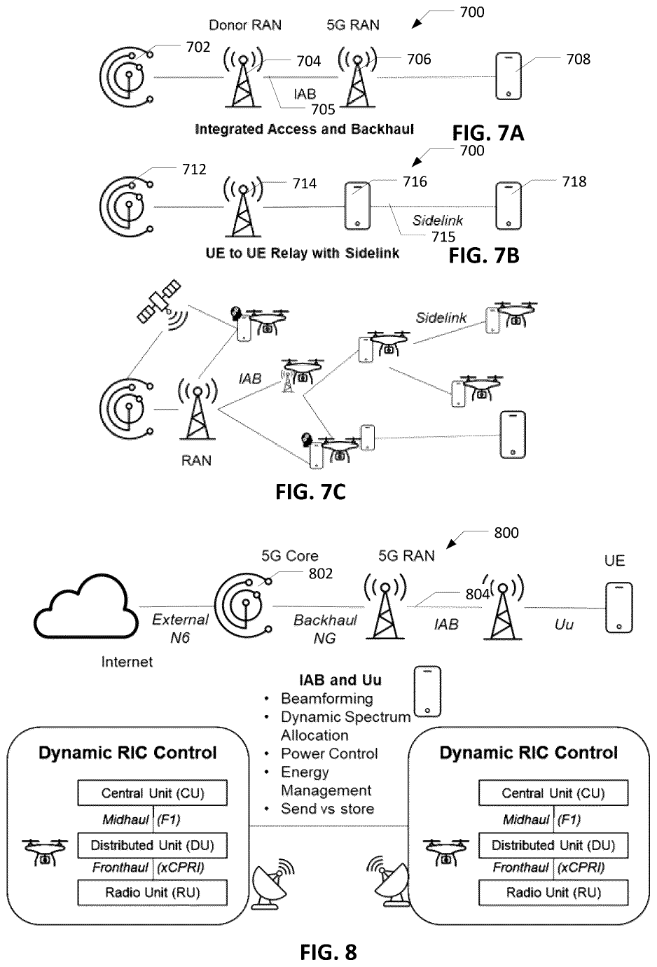

FIG. 7A illustrates a hierarchical mesh network integrating an IAB transport according to various embodiments.

An SDSN 700 may include a 5G base station 704 for a donor RAN 702, and a second 5G base station 706 connected to the 5G base station 704 via an IAB transport 705. The second 5G base station 706 may connect to UE 708 with a standard 5G transport. The second 5G base station 706 may be deployed on a drone (not shown). The UE 708 may be deployed on a drone (not shown). The use of 5G IAB 705 allows the use of the same 5G spectrum to connect donor RAN 702 to a donee RAN (here represented by second 5G base station 706. 5G IAB 705 allows UE 708 to connect to donor RAN 702. 5G IAB 705 enables dynamic and scalable drone operations, for example, with larger drones providing the SDSN backbone layer.

FIG. 7B illustrates a hierarchical mesh network integrating a Sidelink transport according to various embodiments.

An SDSN 710 may include a 5G base station 714 and a first UE 716 connected to a second UE 718 via a Sidelink 715. The first UE 716 may connect to base station 714 with a standard 5G transport. The first UE 716 may be deployed on a drone (not shown). The second UE 718 may be deployed on a drone (not shown). The use of Sidelink 715 allows the use of the same 5G spectrum to connect a RAN 712 to second UE 718.

FIG. 7C illustrates a hierarchical mesh network integrating IAB, Sidelink, and Wi-Fi transports according to various embodiments.

### B. Innovative Role of 5G/O-RAN RIC

O-RAN standards enable innovative approaches towards supporting mission objectives in a dynamic and often adversarial Radio Frequency (RF) environment. RIC is the implementation host for these dynamic network control functions to optimize the use of spectrum, energy, and drone resources to meet challenging mission objectives with O-RAN standards-based improvements.

RIC executes the assigned drone roles (in backbone and coordination layers) in the 5G topology to dynamically control antenna flexibility (directivity and power) vis-a-vis traffic requirements and energy budgets. For higher flying drones, such antenna directivity can help conserve energy as RIC dynamically manages power and sub-allocates spectrum while precisely supporting mission needs. RIC can thus support dynamic spectral reuse by tiling the coverage area with a collection of sub bands (for example, four color reuse). In addition, RIC provides feedback to the applications (5G standards-based) for dynamically deciding, for example, whether to collect and send data with the highest fidelity, reduced resolution, or use local storage for later transmission.

### 1) Onboard 5G Core for Self-Contained Network

FIG. 8 illustrates a SDSN including an O-RAN RIC-based dynamic beam forming and spectrum transport according to various embodiments.

SDSN 800 supports including a tactical core in either of the upper two layers (backhaul and inter-group layer) when a mission plan (for example, mission supporting applications and onboard control) demands either extremely low latency or data sovereignty. Data sovereignty may be used to provide a fully self-contained private network with autonomous decision-making. With an onboard 5G Core 802, user traffic is not communicated to ground while a mission is being executed. In most scenarios, however, a ground based trusted 5G Core as a part of macro 5G network may suffice the swarm needs.

SDSN 800 may include an IAB transport to enable environments lacking local backhaul to maintain connectivity using the 5G spectrum. The IAB transport 804 supports multi-hop connectivity through donor and node RANs, facilitating relay backhaul data wirelessly as discussed above.

SDSN 800 may utilize 5G Sidelink Capabilities to enhance network resilience and flexibility. The 5G Sidelink capabilities may be suitable for Mobile Ad Hoc Networks (MANETs) and other dynamic environments with UE-to-UE direct links. The 5G Sidelink capabilities may be used to support D2D communication to a non-D2D-enabled UE via a Sidelink from a D2D enabled UE to a non-D2D enabled UE. This capability may be crucial in environments where traditional network connectivity is limited.

SDSN 800 may include Hierarchical Mesh Networks to employ a mix of embedded RAN and UE capabilities within drones. The mesh networks may be integrated with IAB and Sidelink. Robust hierarchical mesh networks may be created, updated and managed by the unified management of SDSN 800. This facilitates rapid deployment and scalability through DWM and IP-Level traffic routing (for example, with OSPF).

SDSN 800 supports Open RAN flexibilities by leveraging RIC for IAB enhancements, beam forming antenna control, and contributing to dynamic resource management and optimization. The Open RAN flexibilities enhance the scalability and adaptability of network components connected with O-RAN standards, allowing for tailored configurations that meet diverse operational demands.

### C. Wi-Fi Integration

The integration of Wi-Fi mesh technology into the SDSN provides cost-effective and flexible networking solutions for drone swarms. Leveraging the IEEE 802.11s standardized interfaces, DWM is adapted for mobile nodes, boosting the network's ability to dynamically configure and manage complex swarm operations.

DWM maintains high-throughput and reliable inter-node communication within close ranges, thereby supporting real-time data exchange and control within drone swarms. The scalable nature of DWM allows for efficient handling of increasing network densities to enable large-scale deployments. By enhancing routing protocols and adapting to the mobility of UAVs, DWM ensures that the SDSN remains scalable and resilient under varying operational demands. DWM covers specific gaps in the static Wi-Fi mesh which are summarized in the following table.

TABLE III
WI-FI MESH GAPS AND SDSN APPROACHES

| Layer | Features | Challenges | Solutions |
|---|---|---|---|
| Physical | Uses radio | Dense networks | Enhance signal |
| (PHY) | frequencies for | can cause signal | clarity and reduce |
| | wireless | interference and | interference with |
| | communication, | range limitations. | dynamic beam |
| | employing advanced | | forming and power |
| | technologies like | | control. |
| | Multi-Input, Multi- | | |
| | Output (MIMO) and | | |
| | beamforming for | | |
| | improved range. | | |
| Data | Ensures reliable | Increases in | Implement efficient |
| Link | communication via | device numbers | MAC protocols to |
| | protocols and | cause collisions | reduce collisions |
| | efficient frame | and bandwidth | and optimize |
| | management, | contention. | bandwidth. |
| | handling Media | | |
| | Access Control | | |
| | (MAC) addresses. | | |
| Network | Manages dynamic | High routing table | Utilize self-healing |
| | paths between nodes | sizes and dynamic | routing protocols to |
| | using routing | conditions | adapt to network |
| | protocols, | complicate traffic | changes and |
| | supporting both | management. | maintain consistent |
| | IPv4 and IPv6. | | paths. |

### D. Dynamic Wi-Fi Mesh (DWM) in SDSN

DWM within the SDSN addresses the dynamic and complex requirements of drone swarm communications. DWM builds upon the traditional 802.11 standards and IP routing to specifically cater to the high mobility and variable connectivity environments characteristic of drone operations. This adaptation includes enhancements for mobility management and resource allocation for maintaining stable and efficient connections across swiftly moving drone swarms while using standards-based interfaces to collect network data needed in dynamic routing.

By focusing on refining resource management, link management, and mobility, the DWM significantly mitigates challenges such as signal degradation, bandwidth contention, and dynamic topology changes. These link performance and routing enhancements ensure that the network remains resilient and responsive, providing consistent and reliable communication pathways for the operational success of drone swarms. DWM enhancements leverage standards-based functions and measurements and are typically implemented in Wi-Fi Access Points (APs) so that cost-effective Commercial Off-The-Shelf (COTS) user devices can be used.

TABLE IV
WI-FI STANDARDS USED IN DWM ENHANCEMENTS

| | | Challenges | |
|---|---|---|---|
| Protocol | Key Enhancements | Addressed | Solutions Provided |
| 802.11k | Adaptive | Outdated | Enhance dynamic |
| | measurement | measurements due | use of standardized |
| | intervals and | to rapid topology | measurements to |
| | real-time RRM | changes | handle rapid |
| | | | changes |
| 802.11v | Network-assisted | Energy conservation | Implement dynamic |
| | power saving and | and QoS in dynamic | power control and |
| | client steering | environments | enhance AP-assisted |
| | | | client decisions |
| 802.11r | Secure, low latency | High latency and | Reduce handoff |
| | roaming with re- | security challenges | delays and support |
| | authentication | in transitions | rapid secure |
| | optimization | | transitions |

### E. SDSN DWM Routing

The SDSN utilizes sophisticated routing protocols within its DWM to ensure efficient and reliable communication pathways among the drones. This is needed as the network scales and the operational dynamics of drone swarms become increasingly complex. The routing protocols employed in the SDSN optimize network traffic flow and enhance communication reliability under varying conditions. These protocols include both proactive and reactive strategies to manage the diverse needs of the network.

Proactive routing protocols such as Optimized Link State Routing (OLSR) and Routing Information Protocol (RIP) are utilized to quickly disseminate routing information within the SDSN, thereby minimizing response times to network changes. Reactive protocols such as Ad hoc On-demand Distance Vector (AODV) and Dynamic Source Routing (DSR) allow the network to adaptively discover routes when necessary, reducing overhead. The Hybrid Wireless Mesh Protocol (HWMP) and Babel provide a blend of these approaches, offering flexibility and efficiency in dynamic and decentralized environments typical of drone operations.

These routing protocols maintain the resilience and efficiency of the SDSN, enabling it to support large-scale, reliable drone operations across various scenarios. Their implementation ensures that the network can handle high mobility and frequent topology changes without compromising the QoS. The SDSN selects a specific routing protocol to meet the needs of a mission, available drones, and environmental conditions.

### F. Network Management Features

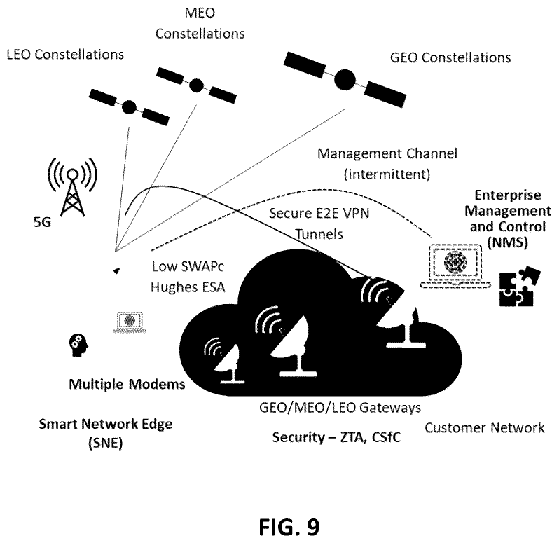

FIG. 9 illustrates a resilient wide-area connectivity overlay on transports according to various embodiments.

The unified management aspects of the SDSN emphasizes the integration of centralized and edge management to ensure optimal network performance and resource utilization. Together, centralized and edge management form a robust framework that supports the SDSN's scalability, security, and efficiency, crucial for its operation in complex drone swarm environments.

Central management, facilitated by the NMS, plays a crucial role in overseeing and coordinating network resources across different layers, ensuring efficient deployment and operation of network services. This includes managing mission plans, energy and spectrum resources, and software configurations for maintaining network integrity and performance.

Centralized control via the NMS provides comprehensive oversight by overseeing all mission and SDSN resources. SDSN resources sustain network operations including energy and spectrum allocations. Centralized control provides deployment coordination. Centralized control manages the deployment, baseline plan distribution, configuration, and coordination of all network nodes and software updates, ensuring that the network's performance and integrity are maintained across various operational scenarios. Centralized control provides situational awareness by collecting and analyzing situational awareness data to inform decision-making, helping to optimize the performance and adaptability of the network. Centralized control may include AI/ML integration to improve network planning and resource allocation, enhancing the network's efficiency and responsiveness.

Edge management focuses on autonomous management at the node level, optimizing gateways and external links according to predefined NMS policies. Local management allows for dynamic adjustments in node roles, performance, and security settings. This enhances the SDSN's ability to respond to changes and threats in real-time. Edge management may be implemented through an SNE and an Edge Management Exchange (SNX).

Edge management autonomously manages gateways and external links in accordance with the overarching policies set by the NMS, enabling quicker local responses to operational changes or security threats. Edge management performs dynamic routing adjustments to optimize data flow and manages VPNs over physical paths, ensuring secure and efficient data transmission. Edge management monitors and adjusts node performance and configurations in real-time, actively managing faults and security settings to maintain network integrity under varying conditions. Edge management supports decentralized control capabilities at the edge, allowing nodes to make independent decisions that align with central policies but are tailored to local conditions, enhancing overall network resilience.

The SDSN leverages established foundational networking elements that set the stage for upcoming developments in drone networking. The network's capabilities support innovative SDSB designs and collaborative engagements.

### V. COLLABORATIVE EXEMPLARY EMBODIMENTS ENABLED BY SDSN

SDSN includes multiple computing elements inter-connected together with scalable networking. This scalable information processing capability enables the introduction of a new class of drone applications where multiple drones can collaborate, for example, by fusing sensor data for enhanced efficiency and system capacity.

### A. Example 1: Picture Stitching

Several drones, per mission plan, can take high fidelity pictures of their respective (and smaller) geographic areas. These pictures can be transmitted to a group-level coordinator which can stitch them together to create a high-resolution picture of a larger area and then quickly distribute it to all collaborating drones. This resultant picture provides situational awareness for each drone as they move per the mission plan. In the absence of the SDSN, this would have required sending all pictures to every drone so that each drone can stitch the final picture (and wasted precious networking, computing resources and limited energy).

### B. Example 2: Scalable RF Sensing

A typical application for a drone swarm could be to perform periodic RF sensing of the environment to assess the dynamic use of the common spectrum. This is a key area for future 6G under the banner of Integrated Sensing and Communication (ISAC). This requires each drone to collect RF energy samples for the entire channel and perform compute intensive processing to detect the RF presence (as noise) or to detect the presence of a specific waveform occupying the channel, Similar to picture stitching, the collaborating drones can collect their RF samples for a smaller sub-channel (or subset of the overall time period) so that the coordinating drone can create a cumulative assessment of RF noise and waveform presence over the time and frequency domains. These maps can then be distributed to each drone and ground for a variety of applications (for example, detection of an adversarial drone, avoiding contested spectrum).

### C. Example 3: Counter Drone Capability

The real-time RF sensing described above is needed, for example, to identify free and unused spectrum to maintain the highest SDSN link capacities. RF sensing can also be used to detect the presence of any third-party RF emitters. Their signals can be tracked in time and space after triangulation as the necessary first step for any counter-drone strategy (especially relevant in military applications).

This counter-drone capability is for ad hoc events and disasters where no terrestrial infrastructure exists (or has been destroyed) to detect unfriendly drones which can complicate the ongoing official business. As drones become more widely availability a timely and reliable detection of any rogue drone operation is important as witnessed during the recent forest/urban fires in California.

### D. Example 4: Real-Time Data Fusion

The backbone layer, with high flying and larger drones, is well equipped to fuse multi-spectral data (including optical, infrared, RF, synthetic aperture RADAR, LiDAR) and help with the detection and recognition of specific objects for a variety of missions. In a dynamic environment this low-latency processing can help save precious time in order to rapidly take a corrective action. For highly dynamic security and safety applications, every millisecond may count.

### E. Agentic AI Autonomy

SDSN enables a networked computing environment with automated software, model and plan distribution under a unified management which can support the use of emerging AI agents and related workflow automation. An agent based on generative AI can provide advanced autonomy for mission, network, and flying tasks under its control while it communicates with other counterpart agents on other drones and ground control to achieve shared mission objectives.

### F. Execute Missions as We Train

The use of ubiquitous cellular (terrestrial and NTN space) for BLOS connectivity, allows military and commercial personnel to train and execute missions on the same COTS equipment which can be taken anywhere in the country and the world. This is especially important to address complex logistical, training, and deployment challenges related to military and disaster response missions.

### VI. CONCLUSION

The SDSN manages complex drone communications within an expansive operational framework. By leveraging a multi-layered network architecture, the SDSN can successfully establish a scalable infrastructure adaptable to a diverse range of operational demands in drone swarm management.

In the SDSN, a hierarchical structure integrates both cellular and advanced Wi-Fi technologies, ensuring extensive connectivity that supports both LOS and BLOS communications, and use of licensed and unlicensed spectrum. This is complemented by the deployment of DWM technology and D2D communications protocols to manage the high dynamics and density of drone operations around the world. Furthermore, the network architecture incorporates sophisticated elements like SNE, SNX and NMS for unified management to facilitate real-time autonomous management. These elements utilize distributed computing models to optimize network traffic and resource allocation dynamically, ensuring sustained high performance and responsiveness across all layers.

The present teachings amplify network-specific topics for unified management of mission priorities, drone roles, energy, and spectrum. These enhancements aim not only to solidify the network's foundational strengths but also to pioneer new integrative approaches for enhancing drone technology in societal applications with multiple organizations collaborating to bring suitable technologies based on open standards. The SDSN is set to drive advancements in drone technology, fostering innovative uses, and transforming drone deployment strategies across multiple industries.

Although the subject matter has been described in language specific to structural features and/or methodological acts, it is to be understood that the subject matter in the appended claims is not necessarily limited to the specific features or acts described above. Rather, the specific features and acts described above are disclosed as example forms of implementing the claims. Other configurations of the embodiments described are part of the scope of this disclosure. Further, implementations consistent with the subject matter of this disclosure may have more or fewer acts than as described or may implement acts in a different order than as shown. Accordingly, the appended claims and their legal equivalents should only define the invention, rather than any specific examples given.

1. A system for large-scale drone deployments, the system comprising:
a Software-Defined Drone Network (SDSN) of drones connected via an integration of a licensed spectrum technology and an unlicensed spectrum technology; and
a unified management module to manage a multi-layered connectivity, communication reliability and quality of service (QoS) for the drones per a baseline plan of a mission,
wherein the SDSN provides the multi-layered connectivity via the integration using a spectrum collection comprising a licensed spectrum and an unlicensed spectrum.

2. The system of claim 1, further comprising an intelligence module configured to enable adaptive routing and decision-making processes by adapting to real-time operational dynamics.

3. The system of claim 2, wherein the intelligence module comprises at least one of an artificial intelligence (AI) algorithm and a machine learning (ML) algorithm.

4. The system of claim 1, wherein the SDSN adapts to one or more of the drones entering and exiting the SDSN while performing the mission.

5. The system of claim 1, wherein the unified management module comprises a dynamic spectrum management module to dynamically manage allocation of the spectrum collection to maintain communication reliability and quality of service (QoS) within the SDSN.

6. The system of claim 1, wherein the unified management module comprises a predictive analytics module to analyze network traffic, to predict a SDSN performance and to allocate SDSN resources based on the SDSN performance.

7. The system of claim 1, wherein the unified management module comprises an energy-efficiency module to implement energy-saving techniques to prolong operation time of one or more of the drones.

8. The system of claim 1, wherein the SDSN is organized as a hierarchical network comprising a backbone layer comprising a backbone drone selected from the drones, a group coordination layer comprising a group coordination drone selected from the drones and a group layer comprising unmanned vehicles selected from the drones.

9. The system of claim 8, wherein the group coordination layer comprises a plurality of group coordination layers, and the backbone layer organizes routing for the plurality of group coordination layers.

10. The system of claim 8, wherein the group layer comprises a plurality of group layers, and the group coordination layer organizes routing for the plurality of group layers.

11. The system of claim 8, wherein one or more of either the backbone drone, the group coordination drone or the unmanned vehicles comprises a RAN Intelligence Controller (RIC).

12. The system of claim 8, wherein the backbone drone comprises a cellular core.

13. The system of claim 8, wherein a correlation between a human operator to the unmanned vehicles is one to many.

14. A method for large-scale drone deployments, the method comprising:
connecting a Software-Defined Drone Network (SDSN) of drones via an integration of a licensed spectrum technology and an unlicensed spectrum technology; and
managing a multi-layered connectivity, communication reliability and quality of service (QoS) for the drones per a baseline plan of a mission,
wherein the SDSN provides the multi-layered connectivity via the integration using a spectrum collection comprising a licensed spectrum and an unlicensed spectrum.

15. The method of claim 14, further comprising enabling adaptive routing and decision-making processes by adapting to real-time operational dynamics using an intelligence module.

16. The method of claim 14, wherein the SDSN adapts to one or more of the drones entering and exiting the SDSN while performing the mission.

17. The method of claim 14, further comprising dynamically managing allocation of the spectrum collection to maintain communication reliability and quality of service (QoS) within the SDSN.

18. The method of claim 14, further comprising analyzing network data, predicting a SDSN performance and allocating SDSN resources based on the SDSN performance.

19. The method of claim 14, further comprising implementing energy-saving techniques to prolong operation time of one or more of the drones.

20. The method of claim 14, wherein the SDSN is organized as a hierarchical network comprising a backbone layer comprising a backbone drone selected from the drones, a group coordination layer comprising a group coordination drone selected from the drones and a group layer comprising unmanned vehicles selected from the drones.
